(19) United States
(12) Patent Application Publication
(10) Pub. No.: US 2004/0091644 A1
(43) Pub. Date: May 13, 2004

(54) Plastic logs

(76) Inventor: Patrick W. Kelley, Saylorsburg, PA (US)

Correspondence Address: Thomas E. Kelley, P.O. Box 302, Mystic, CT, 06355, US

(21) Appl. No.: 10/691,416

(22) Filed: Oct. 22, 2003

Related U.S. Application Data
(62) Division of application No. 10/082,604, filed on Feb. 25, 2002.
(60) Provisional application No. 60/272,743, filed on Mar. 2, 2001.

(51) Int. Cl. A01N 3/00

(52) U.S. Cl. 428/18

(57) ABSTRACT

Plastic logs having a smooth, textured, glossy surface with a nominal diameter greater than 2 inches and a flexural modulus at 40° F. of at least 70,000 psi. Thermoplastic material comprising such logs is preferably substantially polyolefin and other plastic materials having a higher melt temperature, e.g. a melt temperature at least 20° C. higher than the melt temperature of the polyolefin component. Such logs are produced by extrusion through a circular die to a heat transfer medium. Such extruded logs are especially useful for durable fencing.

### RELATED APPLICATION

This application is a division of application Ser. No. 10/082,604, filed Feb. 25, 2002, which claims priority under 35 U.S.C. 119(e) to provisional application Serial No. 60/272,743, incorporated herein by reference.

### FIELD OF THE INVENTION

Disclosed herein are plastic logs which are useful for landscaping and methods of making such logs, e.g. from recycled plastic materials.

### BACKGROUND OF THE INVENTION

Highly segregated and homogenous, scrap plastic can be recycled as molding resin. Mixed plastic typically have a variety of properties, e.g. variable melt temperatures and low values of mechanical properties, that make them difficult to process into useful articles.

Despite the difficulties U.S. Pat. No. 5,916,932 discloses the processing of recycled curbside plastic tailings materials into composite building materials composed of an extruded mixture of high density polyethylene and a thermoplastic coated fiber material such as fiberglass. The plastic tailings is a mixture of recycled plastic with polyethylene terephthalate (PET) soda bottles and high density polyethylene (HDPE) milk and water bottles removed. The plastic tailings typically comprised 90.2% HDPE, 4.5% PET, 3.2% polyvinyl chloride (PVC), 0.5% polypropylene (PP) and 1.6% other plastic. The plastic tailings was mixed with glass fiber and extruded into a mold and water cooled for 3 hours providing a shaped composite useful for railroad tie applications.

An object of this invention is to provide a convenient method for recycling plastic into a log shapes for use as fencing.

### SUMMARY OF THIS INVENTION

This invention provides plastic logs in sizes useful for fence applications, e.g. having an average diameter greater than 2 inches, preferably at least about 3 inches. Such logs are characterized by a flexural modulus at 40° F. of at least 100,000 psi. Such logs are further characterized by a diameter deviation which provides a log-like appearance. In preferred aspects the logs of this invention have a smooth and/or glossy surface, e.g. similar to the texture of barkless logs.

Logs of this invention preferably comprise a substantial amount of recycled thermoplastic material, e.g. at least about 80% thermoplastic material. Preferred aspects of this invention provide plastic logs substantially comprising polyolefin selected from the group consisting of polyethylene (e.g. HDPE) and polypropylene (PP). The composition of such polyolefin logs can preferably further comprise at least one other polymeric material having a melt temperature higher than the polyolefin material, e.g. at least about 20° C. higher than the melt temperature of the polyolefin.

In other aspects of the invention plastic logs can substantially comprise other tough plastics such as ABS and other styrenic polymers, polycarbonates, acrylics, PET and nylons.

This invention also provides methods of producing a plastic, cylindrical log by extruding a plastic material through a circular die to form a cylindrical mass with a molten surface and cooling the molten surface with an air stream. The air stream preferably flows from an annular nozzle proximate to said die.

### BRIEF DESCRIPTION OF THE DRAWINGS

FIG. 1 serves to illustrate an embodiment of heat transfer of an extruded log shape.

### DETAILED DESCRIPTION OF THE PREFERRED EMBODIMENTS

As used herein the term “log” means a nominally cylindrical, extruded shape which can be cut into useful lengths.

As used herein the term “average diameter” is determined from the average of four measurements of log diameter at 45° increments at a cross sectioned cut of a log.

The logs of this invention preferably have a visible deviation in diameter to simulate a natural wood log. Such diameter deviation is be expressed as the percent difference between the minimum diameter (d) and the maximum diameter (D) by the following formula:

Diameter deviation=((D−d)/D)×100

Such diameter deviation is at least 2% and less than 60%, more preferably at least 4% and less than 40%, even more preferably in the range of 5 to 25%.

As used herein the term “flexural modulus” means a measure of resistance to bending and is determined by measuring the deflection (D) resulting from a load (W) on the center span of a length (L) of log of average radius (r). Flexural modulus, E, is determined from the formula

E=(W/D)(L³/12πr⁴)

The logs of this invention preferably have a flexural modulus of at least 70,000 pounds per square inch (psi) at 40° F., more preferably at least 90,000 psi, even more preferably at least 110,000 psi.

The logs of this invention are fabricated from recycled plastic materials, e.g. industrial or household waste. A preferred composition comprises a substantial amount of polyolefin, e.g. preferably at least 80% polyolefin, more preferably at least 90% polyolefin, and selected from the group consisting of polypropylene and the polyethylenes and mixtures thereof. Useful polyethylenes include high density polyethylene (HDPE), low density polyethylene (LDPE) and linear low density polyethylene (LLDPE). The composition can comprise other plastic materials which typically have a higher melting temperature than polyolefin such as PET and PVC. Such other components may be present in blends of polyolefin from industrial scrap, e.g. of polymer blends or alloys. Alternatively, such other components may be present in recycled household plastic scrap. The composition can also comprise other materials commonly found in plastics, e.g. reinforcing fillers and fibers such as glass fiber and high melt temperature fibers. While other filler materials such as wood chips can be used, it is preferred for many applications to keep readily biodegradable materials to a minimum to enhance the durability of the logs. Scrap plastic for recycle is preferably shredded and dried to remove moisture which can vaporize in extruders causing cavitation. Useful drying methods include passing the plastic through a fluidizing bed of low relative humidity air to extract typically surface moisture from the scrap plastic. In general it is not necessary to remove dried “soil”, e.g. residual contents such as food, beverages or cleaners from the plastic. Even with drying some moisture is likely to enter the extruder. Venting practices well known in the extruder art can be employed to remove vaporized moisture from the extruder.

Mixed scrap plastics are preferably blended to provide a composition range requiring minimal adjustments, e.g. in extruder operating temperatures. In preferred embodiments useful compositions include at least 80% polyolefin and the extruder conditions are adjusted for processing a substantially polyolefin composition. It is also preferred to provide a color concentrate to provide natural wood colors to the extruded shape. Desirable colors include shades of browns, yellows and grays to simulate aged wood.

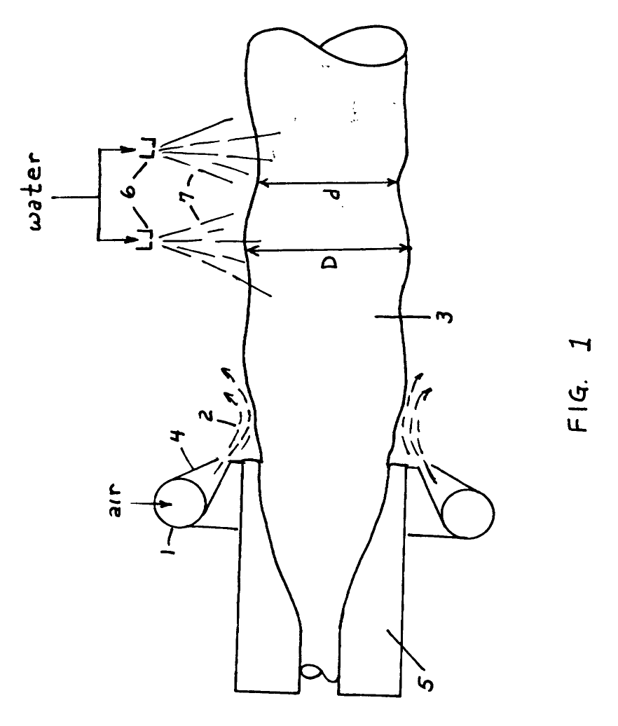

Shredded plastic scrap and color concentrate are fed to a extruder to provide a molten mass at about the melt temperature of the polyolefin component The extrudate is preferably a composite comprising a matrix of molten polyolefin with dispersed particles of higher melting plastic. The extrudate is forced through a circular die to form the log shape. Due to the phenomena of die swell it is useful to employ an extended die with an progressively increasing diameter to minimize swell after the molten mass has left the confinement of the die. It is generally preferred to cool the surface of the extruded shape as uniformly and rapidly as possible using a heat transfer fluid directed from an annular source place close to the die. Useful heat transfer fluids include air and water. Air, e.g. cooled air is a preferred heat transfer fluid which can put a smooth, glossy skin on a log without unduly or inadvertently chilling the die. With reference to FIG. 1 there is shown an embodiment of a heat transfer fluid nozzle 1 for directing a cooling fluid 2, e.g. gas or liquid, to the surface of an extruded shape 3. A nozzle lip 4 directs the fluid away from the face of an expanding circular die 5. After initial heat transfer for forming a skin, supplemental heat transfer can be effected by spray nozzles 6 directing a cooling liquid 7 to the log. Surface deformation at the die to provide a natural texture on the surface is believed to result from a combination of irregular shrinkage and mass migration in the short zone from the edge of the die until a rigid skin is formed by heat transfer. Such natural texture imparts a log like character to an otherwise cylindrical shape.

Because long lengths of extruded log are preferred and because of slow heat transfer into the bulk of the extruded shape it is useful to extruded in a horizontal direction supporting the shape on rollers or other conveyer system as close to the die as possible to minimize distortion from gravity induced sag. Because of the bulk of the log and slow heat transfer it is useful to effect heat transfer by immersion in a heat transfer liquid such as water as the shape is being carried from the die. Immersion can be effected by shower or bath. Moreover, because there is little compressive strength in the molten mass exiting the die, it is useful to carry the shape from the die at a constant speed, e.g. at about the speed of extrusion, to minimize cross sectional distortion. In one preferred embodiment the extruded shape is pulled at faster than the linear speed of extrusion to provide an extruded shape with reduced cross section as compared to the die; such reduced cross-sectioned extruded shapes, e.g. not more than 3.5 inches in average diameter, are especially useful for fence rails. In another preferred embodiment the extruded shape is pulled at slower than the linear speed of extrusion to provide am extruded shape with enlarged cross section as compared to the die; such enlarged cross-sectioned extruded shapes, e.g.. not less than 3.5 inches in average diameter, are especially useful for fence posts. Pulling of the extruded shape can be effected by friction contact with a moving surface.

Cooling is desirable to stabilize the extruded shape. The extruded shape is preferably conveyed in a heat transfer fluid until the outer layers are sufficiently cool to maintain a desired log shape. Logs can be cut from a moving, cooling shape into desired lengths, e.g. 8 to 10 feet is a useful length for fence rails and 5 to 7 feet is a useful length for fence posts. Rail slots in posts can be cut by power saws or mortising drills. Tapered rail ends can be cut by power saw.

The following example illustrates one embodiment of the invention.

### EXAMPLE 1

Plastic scrap consisting essentially of HDPE and PET is shredded, dried and fed to an extruder feed hopper with a brown color concentrate. The extruder heaters are set to bring the plastic mass to a temperatures of 200° C. as it is fed through an expanding circular die having an exit diameter of 3.5 inches. An annular air nozzle is set adjacent to die face to blow cold air along the surface of the extruded shape in the direction of extrudate motion. The extruded shape is supported by a roller conveyor from a distance of about 2 inches from the annular air nozzle through 5 feet of a water shower.

Logs with an average diameter of 3.5 inches were cut in 9 foot lengths and stored on racks to permit air convection cooling of residual heat.

A log produced in this example was supported at an 8 foot span and loaded by an 85 pound weight at mid span. The log deflection was 1.625 inches. Flexural modulus was determined to be about 132,000 psi.

What is claimed is:

1. A plastic log having an average diameter greater than 2 inches, a flexural modulus at 40° F. of at least 70,000 psi and a diameter deviation in the range of 2 to 60%.

2. A plastic log of claim 1 comprising at least 80% of thermoplastic material.

3. A plastic log of claim 2 wherein said thermoplastic material comprises at least one polyolefin selected from the group consisting of polyethylene and polypropylene.

4. A plastic log of claim 3 further comprising at least one other polymeric material having a melt temperature at least 20° C. higher than the melt temperature of said polyolefin.

5. A plastic log having deviations in diameter simulating a natural wood log comprising at least 80% polypropylene and having an average diameter greater than 2 inches, a flexural modulus at 40° F. of at least 90,000 psi and a diameter deviation defined by the algorithm ((D−d)/D)×100 in the range of 2 to 60%, where D is the maximum diameter and d is the minimum diameter.
